(19) United States
(12) Patent Application Publication
(10) Pub. No.: US 2024/0145201 A1
(43) Pub. Date: May 2, 2024

(54) PROTECTIVE ELEMENT AND BATTERY PACK

(71) Applicant: DEXERIALS CORPORATION, Shimotsuke-shi, Tochigi (JP)

(72) Inventor: Chisato KOMORI, Shimotsuke-shi, Tochigi (JP)

(73) Assignee: DEXERIALS CORPORATION, Shimotsuke-shi, Tochigi (JP)

(21) Appl. No.: 18/279,288

(22) PCT Filed: Mar. 11, 2022
(86) PCT No.: PCT/JP2022/011140

§ 371 Date: Aug. 29, 2023

(30) Foreign Application Priority Data
Mar. 16, 2021 (JP) 2021-042754

(51) Int. Cl. H01H 85/055; H01H 85/00; H01H 85/20; H01M 10/42; H01M 10/48; H01M 50/583; H05B 3/26

(52) U.S. Cl. CPC H01H 85/055; H01H 85/0047; H01H 85/20; H01M 10/425; H01M 10/482; H01M 50/583; H05B 3/265; H01M 2200/103

(57) ABSTRACT

A protective element includes a base substrate, a fusible conductor, a heater, and a heater-attached substrate. The base substrate has a first electrode and a second electrode formed thereon, the first electrode and the second electrode each being connected to an external circuit. The fusible conductor is supported on a first surface thereof by the base substrate and connected to the first electrode and the second electrode. The heater is configured to fuse the fusible conductor by generating heat. The heater-attached substrate has the heater provided thereon. The fusible conductor has one contact with the heater-attached substrate and the one contact is positioned on a second surface of the fusible conductor, which is an opposite surface to the first surface.

### TECHNICAL FIELD

The present art relates to a protective element that protects a circuit connected on a current path by fusing the current path and to a battery pack using the protective element. The present application claims priority to Japanese Patent Application No. 2021-042754 which was filed in Japan on Mar. 16, 2021, the contents of which are incorporated herein by reference.

### BACKGROUND TECHNOLOGY

Many rechargeable batteries that can be charged and repeatedly used are processed into battery packs and provided to users. In particular, in a lithium ion rechargeable battery having a high specific energy, in order to ensure the safety of the user and the electronic device, a number of protective circuits such as for overcharge protection, overdischarge protection, and the like are generally built into the battery pack, and a function is provided that interrupts the output of the battery pack in a prescribed situation.

As a protective element for this type of protective circuit for lithium ion rechargeable batteries and the like, a structure is used in which a heater is provided inside the protective element and the fusible conductor on the current path is fused by the heat generated by the heater.

Applications of lithium ion rechargeable batteries have expanded in recent years, and applications with larger currents, for example, in power tools such as electric screwdrivers and the like, and in transportation equipment such as hybrid cars, electric vehicles, and power-assisted bicycles and the like, have begun to be adopted. In these applications, there are cases having a large current exceeding several dozens to hundreds of amperes, particularly at the time of startup or the like. Realization of a protective element that corresponds to such a large current capacity is desired. Furthermore, as adoption in a variety of applications is expanding, the demand for components with few constraints on layout, such as those having a small size and low profile, is increasing.

In order to realize a protective element that can handle such a large Current, a protective element is proposed in which a fusible conductor having an increased cross-sectional area is used and the fusible conductor is connected to the front surface of an insulating substrate having a heater formed thereon.

FIG. 13 is a diagram illustrating one configuration example of a conventional protective element, (A) is a plan view omitting a cover member, and (B) is a cross-sectional view along A-A′. A protective element 100 illustrated in FIG. 13 is provided with: an insulating substrate 101; first and second electrodes 102, 103 formed on the front surface of the insulating substrate 101 and connected on a current path of an external circuit via first and second external connection electrodes 102a, 103a formed on the rear surface of the insulating substrate 101; a heater 104 formed on the front surface of the insulating substrate 101 that generates heat when supplied a current; an insulating layer 105 covering the heater 104; a heater extraction electrode 106 laminated on the insulating layer 105 and connected to the heater 104; and a fuse element 107 equipped across the first electrode 102, the heater extraction electrode 106, and the second electrode 103 via connecting solder.

The heater 104 is connected to a heater supply electrode 108 formed on the front surface of the insulating substrate 101. The heater supply electrode 108 is connected via castellation to a third external connection electrode, not illustrated, formed on the rear surface of the insulating substrate 101. The heater 104 is connected to an external power source provided in an external circuit via the third external connection electrode. Moreover, the current and heat generation of the heater 104 are always controlled by a switch element or the like, not illustrated.

The heater 104 is covered by the insulating layer 105 composed of a glass layer or the like, and overlapped on a heater extraction electrode 106 formed on the insulating layer 105 via the insulating layer 105. The insulating layer 105 is formed by printing and firing, for example, glass paste. Moreover, the fuse element 107 connected between the first and second electrodes 102, 103 is connected on the heater extraction electrode 106.

The fuse element 107 is overlapped on the heater 104 via the insulating layer 105 to thermally connect to the heater 104, and fused when the heater 104 generates heat by a current being supplied.

The fuse element 107 is formed by a low melting point metal such as a Pb-free solder or has a laminated structure in which the low melting point metal is covered by a high melting point metal. The fuse element 107 is connected from the first electrode 102 to the second electrode 103 through the heater extraction electrode 106, thereby constituting a part of a current path of an external circuit in which the protective element 100 is incorporated. The fuse element 107 is fused by self-heating (Joule heating) by the supply of a current exceeding the rated value, or is fused by heat generation of the heater 104, to interrupt connection between the first and second electrodes 102, 103.

When the need arises to interrupt the current path of the external circuit, in the protective element 100, a current is supplied to the heater 104 by the switch element. Thus, the heater 104 generates heat at a high temperature, and melts the fuse element 107 incorporated on the current path of the external circuit. A molten conductor of the fuse element 107 is attracted to the heater extraction electrode 106 and the first and second electrodes 102, 103 having high wettability. Thus, the first electrode 102 to the heater extraction electrode 106 and to the second electrode 103 of the fuse element 107 are fused, and the current path of the external circuit is interrupted.

### CITATION LIST

### Patent Documents

Patent Document 1: Japanese Patent No. 6030431
Patent Document 2: Japanese Patent Application Publication No. 2016-225090
Patent Document 3: Japanese Patent Application Publication No. 2015-228302

### SUMMARY OF INVENTION

### Problem to be Solved by Invention

The melting point of a low melting point metal constituting the fuse element 107 is about 300° C., and performance capable of heat generation up to about 1000° C. is sought the heater 104 for melting this. Moreover, thermal strength that can withstand the heat generation of the heater 104 is sought for the insulating substrate 101 provided by the heater 104, and a ceramic substrate or the like is used.

Moreover, it is necessary that the fuse element 107 as a conductor be connected at least at two places of the first and second electrodes 102, 103 since it is arranged in the current path.

Note that a structure having a heater built in a cover member covering the fuse element is proposed in order to assist the heater on the insulating substrate (Patent Document 1), and a structure interposing a conductive elastic member between the fuse element and a constituent member of a housing side to disperse and mitigate stress (Patent Document 2), and a structure preparing an external electrode terminal to disperse stress by a configuration where the fuse element is supported only by a front surface electrode of the insulating substrate provided with a heater (Patent Document 3) are proposed in order to protect the fuse element from thermal shock.

The inventions described in Patent Documents 1 to 3 given above are extremely simple structures that make it possible to provide a protective element having extremely high safety, but they are structures which connect a fuse element composed of a low melting point metal (mainly a tin or lead solder alloy) on an insulating substrate (mainly a ceramic substrate) that can withstand heat generation of a heater. When the ceramic substrate and the fuse element are exposed to a cooling/heating cycle, mechanical stress is generated due to a difference in linear expansion coefficient, and this stress can cause a problem where the fuse element having lower mechanical strength than the ceramic substrate is gradually torn apart.

In particular, when the cross-sectional area of the low melting point metal is made wide in order to handle a large current, the stress due to linear expansion increases, and therefore, the period until the fuse element breaks tends to be shorter.

The inventions described in Patent Documents 2 and 3 are of a configuration that uses a conductive elastic member and an external electrode, but there is also a problem of being unsuitable for enlarged currents due to an increase of a conductor resistance value by addition of a conductive member, and are problems such as increased size, increased manufacturing man-hours, and increased costs due to an addition of an external electrode.

Therefore, an object of the present art is to provide a protective element that can prevent a fuse element from breaking and handle enlarged currents, and a battery pack using such.

### Means to Solve the Problem

In order to solve the problems described above, a protective element according to the present art includes a base substrate having a first electrode and a second electrode connected to an external circuit, a fusible conductor supported on one surface by the base substrate and connected to the first electrode and the second electrode, and a heater-attached substrate provided with a heater that fuses the fusible conductor by generating heat, wherein the fusible conductor has one contact between another surface and the heater-attached substrate.

Moreover, a battery pack according to the present art includes one or more battery cells, a protective element which is connected to the charge/discharge path of the battery cell and which interrupts the charge/discharge path, and a current control element which detects a voltage value of the battery cell and controls supply of current to the protective element, wherein the protective element includes a base substrate having a first electrode and a second electrode connected to an external circuit, a fusible conductor supported on one surface by the base substrate and connected to the first electrode and the second electrode, and a heater-attached substrate provided with a heater that fuses the fusible conductor by generating heat, wherein the fusible conductor has one contact between another surface and the heater-attached substrate.

### Effect of the Invention

According to the present art, because there is one contact between the fusible conductor and the heater-attached substrate, the fusible conductor does not suffer from damage such as distortion or breakage due to internal stress even when exposure to a high temperature environment and a low temperature environment is repeated, and stability of the external shape and dimensions is obtained. Thus, the protective element and the battery pack according to the present art has a stable resistance value of the fusible conductor and can maintain a high rated value.

### BRIEF DESCRIPTION OF THE DRAWINGS

FIG. 1 is a diagram illustrating a protective element in which the present art is applied, where (A) is a plan view, (B) is a cross-sectional view along B-B′, and (C) is a cross-sectional view along A-A′.

FIG. 2 is a plan view illustrating a base substrate 2.

FIG. 3 is a cross-sectional view illustrating a state in which the fusible conductor is melted.

FIG. 4 is a cross-sectional perspective view illustrating the fusible conductor.

FIG. 5 is a diagram illustrating a circuit configuration of protective element.

FIG. 6 is a cross-sectional view illustrating a modified example of the protective element.

FIG. 7 is a diagram illustrating a circuit configuration of the protective element according to a modified example.

FIG. 8 is a cross-sectional view illustrating pie of protective element.

FIG. 9 is a cross-sectional view illustrating a modified example of protective element.

FIG. 10 is a cross-sectional view illustrating a modified example of e protective element.

FIG. 11 is a cross-sectional view illustrating a modified example of the protective element.

FIG. 12 is a circuit diagram illustrating a configuration example of a battery pack.

FIG. 13 is a diagram illustrating one configuration example of a conventional protective element, where (A) is a plan view illustrating omitting a cover member, and (B) is a cross-sectional view along A-A′.

### DESCRIPTION OF THE EMBODIMENTS

A protective element to which the present art is applied and a battery pack using such are described in detail below with reference to drawings. Note that the present art is not limited to only the embodiments below, and it is obvious that various changes are possible within a scope that does not depart from the spirit of the present art. Moreover, the drawings are schematic, and the ratios and the like of each dimension may differ from the actual ones. The specific dimensions and the like should be determined in view of the following description. Moreover, it is obvious that portions where the mutual dimensional relationships and ratios are different are included among the drawings.

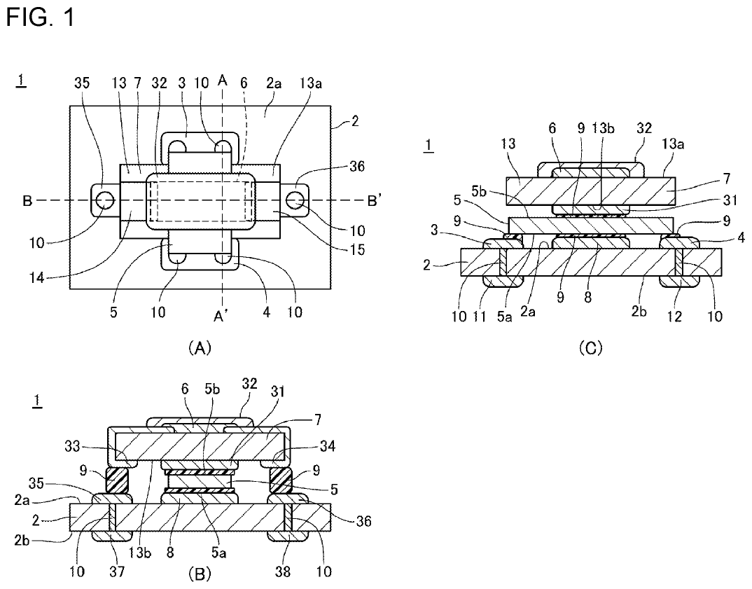

As illustrated in FIG. 1, a protective element 1 to which the present art applied is provided with a base substrate 2 having a first electrode 3 and a second electrode 4 connected to an external circuit, a fusible conductor 5 supported on one surface 5a of the base substrate 2 and connected to the first electrode 3 and the second electrode 4, and a heater-attached substrate 7 provided with a heater 6 that fuses the fusible conductor 5 by generating heat.

The fusible conductor 5 has one contact between another surface Sb and the heater-attached substrate 7. Here, as will be described below, the heater-attached substrate 7 provided with the heater 6 requires a thermal strength to withstand heat generation of the heater 6, and therefore, a ceramic substrate or the like is used. Meanwhile, the fusible conductor 5 has a low melting point metal as a main component that can be melted by the heat generation of the heater 6. Because of this, there is a difference in linear expansion coefficient between the fusible conductor 5 and the heater-attached substrate 7, and when there are a plurality of contacts between the fusible conductor 5 supported by the base substrate 2 and the heater-attached substrate 7, internal stress is generated in the fusible conductor 5 due to the difference in linear expansion coefficient from the ceramic substrate when exposure to a high temperature environment and a low temperature environment is repeated due to reflow mounting or the usage environment of the mounted product, and damage such as distortion or breakage can occur.

However, in the protective element 1, because there is one contact between the fusible conductor 5 and the heater-attached substrate 7, the fusible conductor 5 does not suffer from damage such as distortion or breakage due to internal stress even when exposure to a high temperature environment and a low temperature environment is repeated, and stability of the external shape and dimensions is obtained. Thus, in the protective element 1, the resistance value of the fusible conductor 5 is stabilized and a high rated value can be maintained.

Moreover, in a situation where there is a plurality of contacts with the heater-attached substrate 7, when the cross-sectional area of the fusible conductor 5 is made wide in order to handle a large current, the stress caused by the difference in linear expansion coefficient from the heater-attached substrate 7 increases, and therefore, the period until breakage tends to be shorter. However, in the protective element 1, generation of internal stress and damage due to a difference in linear expansion coefficient from the heater-attached substrate 7 is prevented, and therefore, it is possible to handle large currents by increasing the cross-sectional area of the fusible conductor 5.

Note that the fusible conductor 5 has a plurality of contacts with constituent elements of the base substrate 2 such as the first and second electrodes 3, 4, but the base substrate 2 is not provided with the heater 6, and because heat resistance is low and materials having a small linear expansion coefficient difference can be used, breakage, deformation, and the like due to internal stress caused by a difference in linear expansion coefficient from the base substrate 2 hardly occur.

That is, the protective element 1 is structurally able to mitigate thermal shock to the fusible conductor 5. A detailed configuration of the protective element 1 will be described below.

[Base Substrate]

The base substrate 2 is formed by a member having an insulating property such as a glass epoxy substrate, or a phenol substrate.

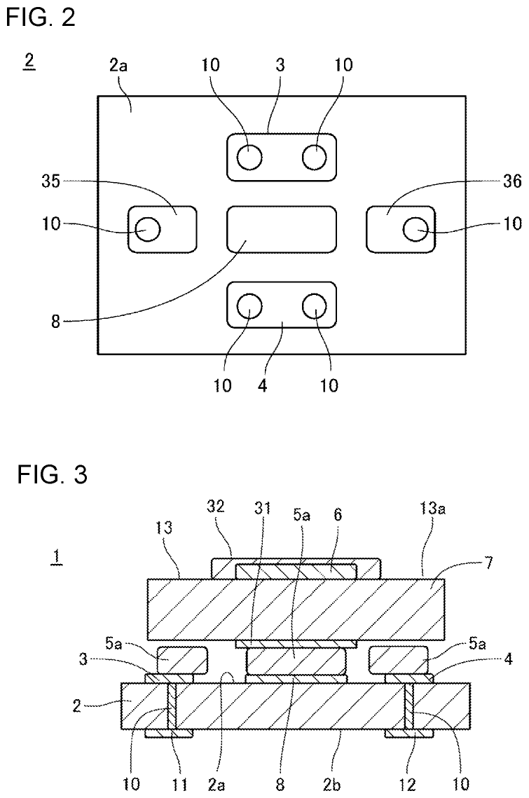

As illustrated in FIG. 2, the first and second electrodes 3, 4 are formed on both opposing end portions of the base substrate 2. The first and second electrodes 3, 4 are respectively formed by a conductive pattern such as Ag or Cu. Moreover, it is preferable that a film such as Ni/Au plating, Ni/Pd plating, Ni/Pd/Au plating is coated on the front surfaces of the first and second electrodes 3, 4 by a known method such as a plating process. Thus, the protective element 1 can prevent oxidation of the first and second electrodes 3, 4 and can prevent variation of rated value accompanying an increase of conduction resistance. Moreover, when the protective element 1 is mounted by reflow, the first and second electrodes 3 and 4 can be prevented from being corroded (solder corrosion) by melting of the connection solder connecting the fusible conductor 5.

The first electrode 3 is connected from a front surface 2a of the base substrate 2 to a first external connection electrode 11 formed on a rear surface 2b via a conductive through-hole 10 that penetrates the base substrate 2. Moreover, the second electrode 4 is connected from the front surface 2a of the base substrate 2 to a second external connection electrode 12 formed on the rear surface 2b via the conductive through-hole 10. When the protective element 1 is mounted on an external circuit board, the first and second external connection electrodes 11, 12 are connected to connection electrodes provided on the external circuit board, whereby the fusible conductor 5 is incorporated into a part of the current path formed on the external circuit board. Note that, the connection between the first and second electrodes 3, 4 and the first and second external connection electrodes 11, 12 may be performed via castellation formed on a side edge of the base substrate 2.

The first and second electrodes 3, 4 are electrically connected via the fusible conductor 5 by equipping the fusible conductor 5 via a conductive connection material 9 such as connection solder. Moreover, as illustrated in FIG. 3, the connection of the first and second electrodes 3, 4 is interrupted by the fusible conductor 5 fusing due to self-heating (Joule heat) due to a large current exceeding a rated value flowing in the protective element 1, or by the fusible conductor 5 fusing due to heat generated by the heater 6 to which a current is supplied.

Moreover, the base substrate 2 is provided with a retaining part 8 that retains the molten conductor 5c of the fusible conductor 5 between the first electrode 3 and the second electrode 4. The retaining part 8 is formed by a material having excellent wettability with respect to the molten conductor 5c and can be formed by, for example, a conductive pattern such as Ag or Cu. Moreover, the retaining part 8 may be formed by the same material as the first and second electrodes 3, 4, and thereby, can be formed simultaneously through the same forming process. The retaining part 8 is connected to the fusible conductor 5 via a connecting material having excellent thermal conductivity such as a conductive connection material 9.

Note that the conductive connection material 9 may be a metal joining material having a melting point no greater than a low melting point metal configuring the fusible conductor 5, for example, a tin-based alloy such as Sn—Ag, Sn—Ag—Cu, Sn—Bi, and Sn—Bi—Sb, a lead-based alloy such as Pb—Sn and Pb—Au, and an indium-based alloy such as Pb—In and In—Sn. Moreover, the base substrate 2 may be provided with a solder resist with an object of insulation or controlling the position of fusible conductor 5.

The base substrate 2, unlike an insulating substrate in a conventional protective element, is not provided with the heater 6. Because of this, the base substrate 2 is not required to have high heat resistance, and it is also possible to use a base material having low heat resistance. Therefore, a material having a small difference in coefficient of linear expansion from the fusible conductor 5 can be used as the base material of the base substrate 2.

Thus, even when the protective element 1 is repeatedly exposed to a high temperature environment and a low temperature environment, the base substrate 2 can suppress the occurrence of large internal stress between the base substrate and the fusible conductor 5, can prevent the occurrence of damage such as distortion or breakage due to internal stress in the fusible conductor 5, and can maintain stability of the external shape and dimensions.

[Fusible Conductor]

Next, the fusible conductor 5 will be described. The fusible conductor 5 is mounted between the first and second electrodes 3, 4, fuses by a generation of heat by supplying current to the heater 6, or by self-heating (Joule heat) by supplying a current exceeding a rated value, and interrupts a current path between the first electrode 3 and the second electrode 4.

The fusible conductor 5 may be a low melting point metal material that has a conductivity which can melt due to heat generation by supplying current to the heater 6 or due to an over-current state, and for example, SnAgCu-type Pb free solder, BiPbSn alloy, BiPb alloy, BiSn alloy, SnPb alloy, PbIn alloy, ZnAl alloy, InSn alloy, PbAgSn alloy, or the like may be used.

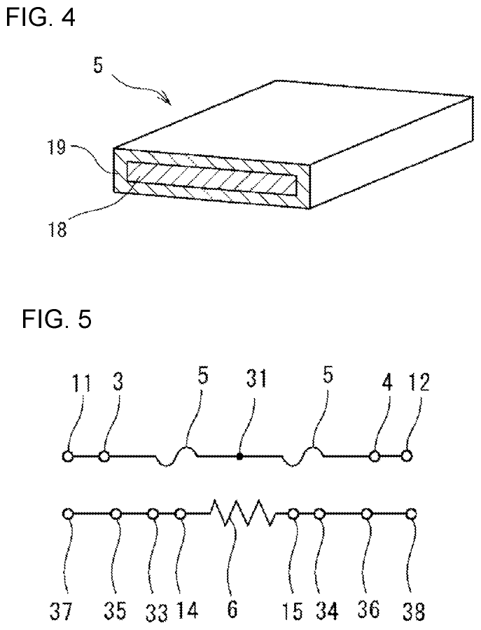

Moreover, the fusible conductor 5 may be a structure containing a high melting point metal and a low melting point metal. For example, as illustrated in FIG. 4, the fusible conductor 5 is a laminated structure composed of an inner layer and an outer layer and has a low melting point metal layer 18 as the inner layer and a high melting point metal layer 19 as the outer layer laminated on the low melting point metal layer 18. The fusible conductor 5 is connected via a conductive bonding material 9 such as a connecting solder on the first and second electrodes 3, 4 and the retaining part 8.

The low melting point metal layer 18 is preferably solder or a metal having Sn as a main component, and is a material generally called “Pb free solder”. The melting point of the low melting point metal layer 18 does not necessarily need to be higher than the temperature of the reflow oven, and may be melted at about 200° C., The high melting point metal layer 19 is a metal layer laminated on the surface of the low melting point metal layer 18, and is, for example, Ag, Cu, or a metal having either of these as a main component, and has a high melting point that does not melt even when connecting the first and second electrodes 3, 4, the retaining part 8, and the fusible conductor 5 or mounting on the external circuit board of the protective element 1 by reflow.

This type of fusible conductor 5 can be formed by forming a high melting point metal layer on a low melting point metal foil using a plating technique, or can be formed using other well-known laminating technique or film forming technique. At this time, the fusible conductor 5 may have a structure where the entire surface of the low melting point metal layer 18 is covered by the high melting point metal layer 19, and it may have a structure where a pair of opposing side surfaces are excluded from being covered. Note that the fusible conductor 5 may be formed with a variety of configurations such as having the high melting point metal layer 19 as the inner layer and the low melting point metal layer 18 as the outer layer, or having a multilayer structure of three or more layers where the low melting point metal layer 18 and the high melting point metal layer 19 are alternately, laminated, or providing an opening in a portion of the outer layer to expose a portion of the inner layer.

The shape of the fusible conductor 5 can be maintained even when the reflow temperature exceeds the melting temperature of the low melting point metal layer 18 by laminating the high melting point metal layer 19 as the outer layer on the low melting point metal layer 18 that becomes the inner layer, and fusing does not occur. Therefore, the connection between the first and second electrodes 3, 4 and the retaining part 8 and the fusible conductor 5, and the mounting of the protective element 1 on the external circuit board can be efficiently performed by reflow, and fluctuation in the fusing characteristics such as not fusing at a predetermined temperature or fusing at less than the predetermined temperature due to a local increase or decrease in the resistance value in conjunction with deformation of the fusible conductor 5 can be prevented even by reflow.

Moreover, the fusible conductor 5 is not fused by self-heating while a predetermined rated current is flowing. When a current having a value higher than the rated value flows, melting occurs due to self-heating, and the current path between the first and second electrodes 3, 4 is interrupted. Moreover, the heater 6 is supplied with a current and melted by heat generation, and the current path between the first and second electrodes 3, 4 is interrupted.

At this time, the fusible conductor 5 liquefies at a temperature lower than the melting temperature of the high melting point metal layer 19 due to the melted low melting point metal layer 18 corroding the high melting point metal layer 19 (solder corrosion). Therefore, the fusible conductor 5 can be fused in a short period of time using the erosion effect of the high melting point metal layer 19 by the low melting point metal layer 18. Moreover, because the molten conductor 5c of the fusible conductor 5 is divided by the physical pulling-in action of the retaining part 8 and the first and second electrodes 3, 4, the current path between the first and second electrodes 3, 4 can be quickly and reliably interrupted (FIG. 3).

Moreover, the fusible conductor 5 is preferably, formed so that the volume of the low melting point metal layer 18 is larger than the volume of the high melting point metal layer 19. The fusible conductor 5 is heated by self-heating due to an overcurrent or by heat generation of the heater 6, and the high melting point metal is corroded by the low melting point metal melting, and as a result, can be rapidly, melted and fused. Therefore, the fusible conductor 5, by having the volume of the low melting point metal layer 18 formed larger than the volume of the high melting point metal layer 19, the corrosion effect is promoted and the connection between the first and second electrodes 3, 4 can be quickly interrupted.

Moreover, the fusible conductor 5 is configured having the high melting point metal layer 19 laminated on the low melting point metal layer 18 that becomes the inner layer, and thereby, the fusing temperature can be greatly reduced as compared with a conventional chip fuse or the like composed of a high melting point metal. Therefore, the fusible conductor 5 can be made larger in cross-sectional area than a chip fuse or the like of the same size, and can be greatly improved in current rating. Moreover, the conductor can be made smaller and thinner than conventional chip fuses having the same current rating, and has excellent quick fusing properties.

Moreover, the fusible conductor 5 can improve resistance to surges (pulse resistance) where an abnormally high voltage is momentarily applied to an electric system in which the protective element 1 is incorporated. In other words, the fusible conductor 5 must not be fused when, for example, a current of 100 A flows for several milliseconds. At this point, because a large current that flows in an extremely short period of time flows through the surface layer of the conductor (skin effect), the fusible conductor 5 is provided with a high melting point metal layer 19 such as Ag plating having a low resistance value as an outer layer, and therefore, it is easy to pass a current applied by a surge, and fusing by self-heating can be prevented. Therefore, the fusible conductor 5 can remarkably improve the resistance to surges in comparison with a fuse composed of a conventional solder alloy.

In this kind of fusible conductor 5, the one surface 5a supported by the first and second electrodes and the retaining part 8 and the other surface Sb on the opposite side are in contact with the heater-attached substrate 7. The protective element 1 has one contact between the other surface Sb of the fusible conductor 5 and the heater-attached substrate 7.

[Heater-Attached Substrate]

The heater-attached substrate 7 has an insulating substrate 13, and a heater 6 formed on the insulating substrate 13 and which fuses the fusible conductor 5 by heat generation.

[Insulating Substrate]

The insulating substrate 13 is formed by a base material having an insulating property and providing resistance to heat generation of the heater 6, such as alumina, glass ceramics, mullite, or zirconia. Among these, a ceramic substrate having excellent heat resistance to high temperature heat generation of the heater 6 is preferably used.

As illustrated in FIG. 1, the insulating substrate 13 has a heater 6 formed on the front surface 13a, and an intermediate electrode 31 connected to the other surface Sb of the fusible conductor 5 formed on the rear surface 13b. The intermediate electrode 31 is connected to the other surface Sb of the fusible conductor 5 by the conductive connection material 9 such as connection solder. In the intermediate electrode 31, when the fusible conductor 5 melts, the molten conductor 5c coheres and is held together with the retaining part 8 formed on the base substrate 2.

[Heater]

The heater 6 is a member having conductivity that generates heat when current is supplied with a relatively high resistance value, and is composed of, for example, Nichrome, W, Mo, Ru, or the like or a material containing these. The heater 6 may be formed by pattern forming paste obtained by mixing an alloy of these, compositions, or compound powders with a resin binder or the like, using a screen printing technique on the insulating substrate 13, and firing or the like. As one example, the heater 6 can be formed by adjusting a mixed paste of ruthenium oxide based paste, silver, and glass paste according to a predetermined voltage, forming a film of a predetermined area at a predetermined position on the front surface 13a of the insulating substrate 13, and then performing a firing process under appropriate conditions. Moreover, the shape of the heater 6 may be suitably designed, but as illustrated in FIG. 1, making it substantially rectangular according to the shape of the insulating substrate 13 is preferable in maximizing the heat generation area.

Moreover, first and second heater electrodes 14, 15 that configure a power supply path to the heater 6 are formed on the front surface 13a whereon the heater 6 of the insulating substrate 13 is formed. The first heater electrode 14 is formed on one side edge of the front surface 13a of the insulating substrate 13, and the second heater electrode 15 is formed on the other side edge on the opposite side of the one side edge. The heater 6 is connected by overlapping one end with the first heater electrode 14, and connected by overlapping the other end with the second heater electrode 15.

The first heater electrode 14 and the second heater electrode 15 are electrodes that serve as power supply terminals to the heater 6, wherein the first heater electrode 14 is connected to a first heater supply electrode 33 provided on the rear surface 13b of the insulating substrate 13 via castellation, and the second heater electrode 15 is connected to a second heater supply electrode 34 provided on the rear surface 13b of the insulating substrate 13 via castellation. The first heater supply electrode 33 and the second heater supply electrode 34 are connected to a third electrode 35 and a fourth electrode 36 formed on the front surface 2a of the base substrate 2 by the conductive connection material 9 or the like.

The third electrode 35 is connected from the front surface 2a of the base substrate 2 to a third external connection electrode 37 formed on the rear surface 2b via the conductive through-hole 10 that penetrates the base substrate 2. Moreover, the fourth electrode 36 is connected from the front surface 2a of the base substrate 2 to a fourth external connection electrode 38 formed on the rear surface 2b via the conductive through-hole 10. When the protective element 1 is mounted on an external circuit board, the third and fourth external connection electrodes 37, 38 are connected to connection electrodes provided on the external circuit board, and are thereby incorporated into a part of the power supply path that supplies power to the heater 6. As illustrated in FIG. 5, the power supply path to the heater 6 is formed independently of the current path of the fusible conductor 5. Note that the connection between the third and fourth electrodes 35, 36 and the third and fourth external connection electrodes 37, 38 may be performed via castellation formed on a side edge of the base substrate 2.

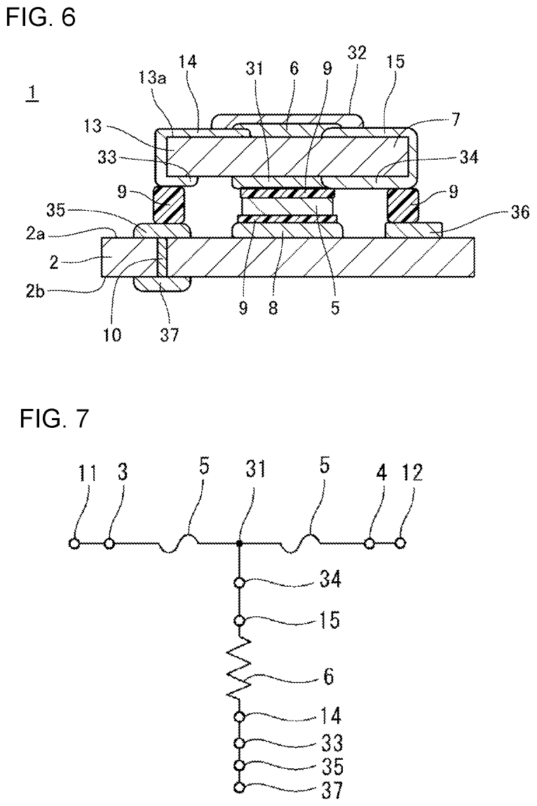

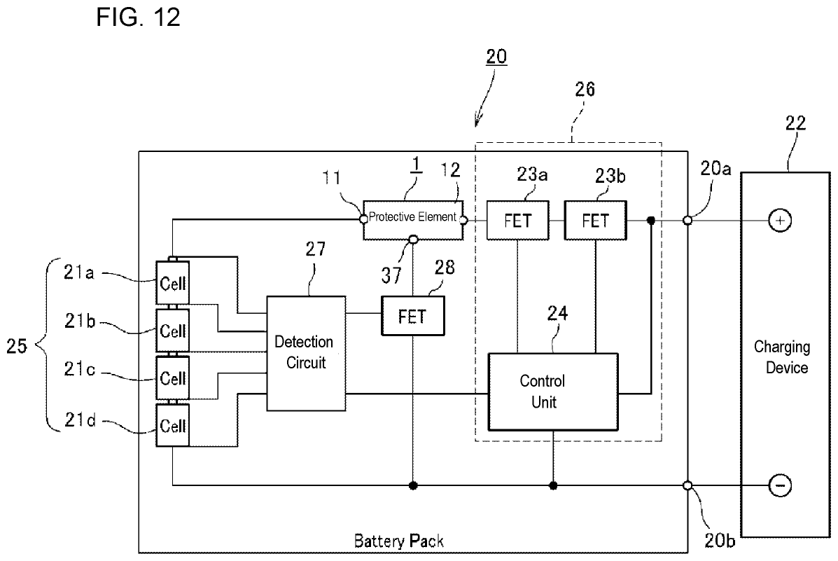

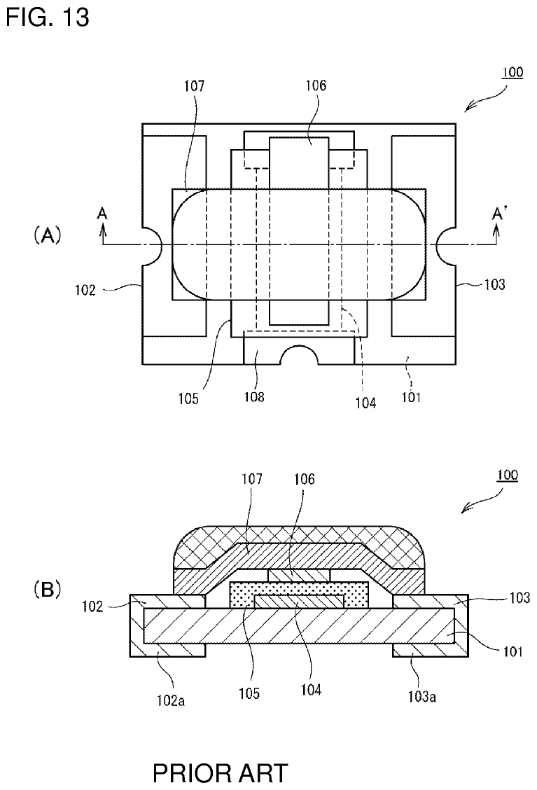

Note that the protective element 1, as illustrated in FIG. 6 and FIG. 7, may link the power supply path to the heater 6 to the current path of the fusible conductor 5. In this situation, the second heater supply electrode 34 is connected to the intermediate electrode 31 formed on the rear surface 13b of the insulating substrate 13, and the fourth external connection electrode 38 is not provided. Thus, when the protective element 1 is incorporated into a battery pack 20 that will be described below (see FIG. 12), the heater 6 is supplied with power from a battery stack 25, and the power supply path is interrupted by fusing of the fusible conductor 5 and heat generation stops. Note that the second heater electrode 15 may be connected to the intermediate electrode 31 via a conductive through-hole that is not illustrated provided on the insulating substrate 13.

The first and second heater electrodes 14, 15, the first and second heater supply electrodes 33, 34, and the intermediate electrode 31 may be formed by printing and firing a conductive paste such as Ag or Cu. Moreover, the electrodes formed on the front surface 13a or the rear surface 13b of the insulating substrate 13 may be formed by one printing and firing process by configuring using same material.

The heater 6 is protected and insulated by being covered by the insulating layer 32 composed of a glass layer or the like. The insulating layer 32 may be fonned by coating and firing, for example, a glass-based paste. Moreover, the insulating substrate 13 may be provided with a solder resist with an object of insulation.

The first and second heater supply electrodes 33, 34 formed on the rear surface 13b of the heater-attached substrate 7 are connected to the third and fourth electrodes 35, 36 formed on the front surface 2a of the base substrate 2 via the conductive connection material 9. Moreover, an intermediate electrode 31 formed on the rear surface 13b of the heater-attached substrate 7 is connected to the other surface 5b of the fusible conductor 5 via the conductive connection material 9. Thus, the heater-attached substrate 7 is connected to the base substrate 2. At this time, the fusible conductor 5 has one contact with the heater-attached substrate 7, and the heater 6 is formed on the surface side opposite to the surface in contact with the fusible conductor 5 of the heater-attached substrate 7.

Note that the protective element 1 is protected by being covered by a case inside not illustrated in the drawing. The case may be formed using a member having an insulating property such as various engineering plastics, thermoplastic plastics, ceramics, glass epoxy substrates, and the like.

According to such a protective element 1, because there is one contact between the fusible conductor 5 and the heater-attached substrate 7, damage such as distortion or breakage due to internal stress of the fusible conductor 5 can be suppressed even when exposure to a high temperature environment and a low temperature environment is repeated. Moreover, the insulating substrate 13 of the heater-attached substrate 7 can also use a ceramic substrate or the like having excellent heat resistance without considering the difference in coefficient of linear expansion with respect to the fusible conductor 5, and a protective element can be provided that improves heat resistance as an element structure, enables the desired design of the heat generation temperature of the heater 6, increases the cross-sectional area of the fusible conductor 5 to achieve a high rated value, and has excellent rapid fusing properties.

Furthermore, it is possible to use a base material having a smaller linear expansion coefficient difference from the fusible conductor 5, as the base substrate 2 for supporting the fusible conductor 5. The greater the difference in the linear expansion coefficient between the materials, the greater the generated stress, and therefore reducing the difference in the linear expansion coefficients leads to increasing durability against thermal shock. For example, while the linear expansion coefficient of a ceramic base material is 7.2 (ppm/® C.), the linear expansion coefficient of a glass epoxy base material is 14 (ppm/° C.). Moreover, the linear expansion coefficient of tin is 26.9 (ppm/° C.), and the linear expansion coefficient of lead is 29.1 (ppm/° C.), used as the material of the fusible conductor 5.

Since the linear expansion coefficient difference between the ceramic base material and tin is about 20 and that between the glass epoxy base material and tin is about 13, the linear expansion coefficient difference is reduced by about 40% by changing the base substrate 2 from a ceramic substrate to a glass epoxy substrate. Therefore, a structure is provided in which the generated stress can also be reduced by 40%. Accordingly, by using, as the base substrate 2, a substrate having a linear expansion coefficient difference with respect to the linear expansion coefficient of the fusible conductor 5 that is smaller than the insulating substrate 13 of the heater-attached substrate 7, the heat resistance of the fusible conductor 5 with respect to a cold/hot cycle in which exposure to a high temperature environment and a low temperature environment is repeated can be improved.

Moreover, with regard to the conductor resistance of the base substrate 2, the conductor resistance value of the material used in the first and second electrodes 3, 4 is equivalent to that of the ceramic substrate, and therefore, a resistance value equal to or greater than that of the ceramic substrate can be realized.

Moreover, even when a glass epoxy base material is used as the base substrate 2, by forming the first and second external connection electrodes 11, 12 in the same manner as the ceramic base material, it can be configured as a protective element that can be mounted on the front surface, and it can be made small as a structure without a need to use an external electrode terminal or the like.

### Modified Example 1

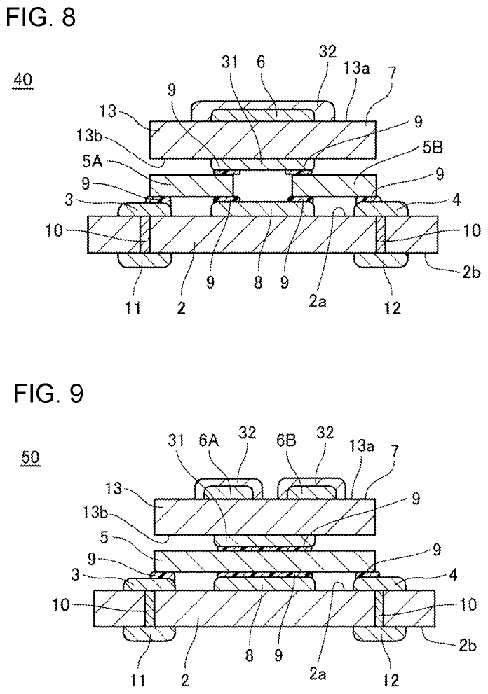

Next, a modified example of a protective element to which the present art is applied will be described. Note that configurations identical to those of the protective element 1 described above are labeled with the same reference signs and details thereof are omitted in the description below. The protective element to which the present art is applied may be provided with a plurality of fusible conductors. The protective element 40 illustrated in FIG. 8 is provided with two fusible conductors 5A, 5B on the base substrate 2. The fusible conductor 5A is provided between the first electrode 3 and the retaining part 8, and the fusible conductor 5B is provided between the second electrode 4 and the retaining part 8. Moreover, in the intermediate electrode 31 of heater-attached substrate 7, contacts are formed by a number corresponding to the number of the fusible conductor 5 provided on the base substrate 2, and in the protective element 40 illustrated in FIG. 8, the intermediate electrode 31 is connected to each fusible conductor 5A, 5B at two contacts.

Even in the protective element 40, the fusible conductor has one contact between the other surface and the heater-attached substrate. That is, the fusible conductor 5A contacts the intermediate electrode 31 at one point, and the fusible conductor 5B contacts the intermediate electrode 31 at one point. Therefore, even when repeatedly exposed to a high temperature environment and a low temperature environment, the protective element 40 can prevent internal stress from being generated in the fusible conductors 5A, 5B due to a difference in linear expansion coefficients from the insulating substrate 13, and damage such as distortion and breakage from being generated.

Note that three or more fusible conductors 5 may be provided. Moreover, a plurality of the fusible conductor 5 may be provided by arranging in parallel across the first and second electrodes 3, 4 and the retaining part 8 in a plan view of the base substrate 2. The size, configuration, material, resistance value, thermal conductivity, and other physical properties of the plurality of fusible conductors 5 may be the same or different.

Moreover, a plurality of the intermediate electrode 31 may be formed according to the number of the fusible conductor 5, and there may be one contact between each intermediate electrode 31 and each fusible conductor 5.

### Modified Example 2

Moreover, the protective element to which the present art is applied may be provided with a plurality of heaters. The protective element 50 illustrated in FIG. 9 is provided with two heaters 6A, 6B on the heater-attached substrate 7. The heaters 6A, 6B are connected by overlapping respective one ends with the first heater electrode 14, and connected by overlapping the other ends with the second heater electrode 15. The configuration of the power supply path to the heater 6 from the first heater electrode 14 and the second heater electrode 15 and thereafter is similar to that of the protective element 1 described above.

Even in the protective element 50, the fusible conductor has one contact between the other surface and the heater-attached substrate. That is, the fusible conductor 5 contacts at one point of the intermediate electrode 31. Therefore, even when repeatedly exposed to a high temperature environment and a low temperature environment, the protective element 50 can prevent internal stress from being generated in the fusible conductor 5 due to a difference in linear expansion coefficients from the insulating substrate 13, and damage such as distortion and breakage from being generated.

### Modified Example 3

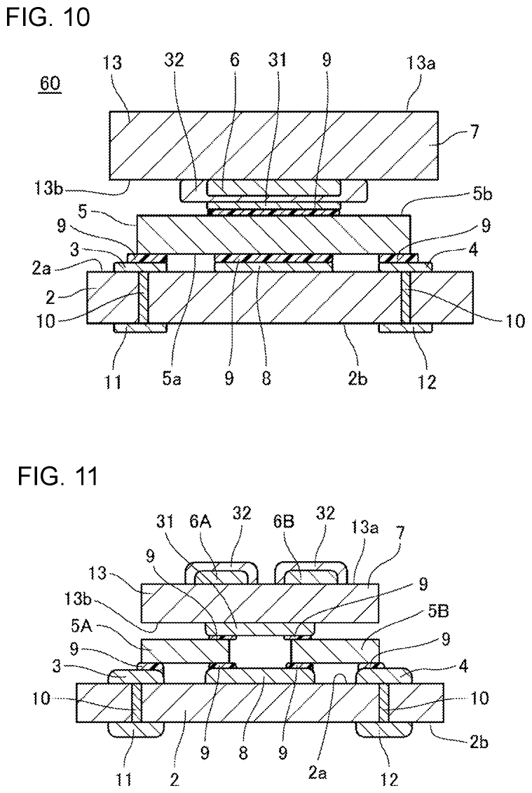

Moreover, in the protective element to which the present art is applied, the heater may be formed on a surface side that contacts the fusible conductor of the heater-attached substrate. The protective element 60 illustrated in FIG. 10 is provided a heater 6 on the rear surface 13b of the insulating substrate 13 of the heater-attached substrate 7. The heater 6 is protected and insulated by being covered by the insulating layer 32. Moreover, the intermediate electrode 31 connected to the second heater electrode 15 is overlapped on the insulating layer 32.

The intermediate electrode 31 is overlapped on the heater 6 via the insulating layer 32. Moreover, the intermediate electrode 31 is connected to the other surface 5b of the fusible conductor 5 via the conductive connection material 9. That is, in the protective element 60, the heater 6 is formed on a surface side that contacts the fusible conductor 5 of the heater-attached substrate 7.

Moreover, because the first and second heater electrodes 14, 15 are also formed on the rear surface 13b of the insulating substrate 13, they are connected to the third and fourth electrodes 35, 36 formed on the base substrate 2 without a need to form first and second heater current conducting electrodes 33, 34. The intermediate electrode 31 is formed from the second heater electrode 15 to the insulating layer 32.

Even in the protective element 60, the fusible conductor has one contact between the other surface and the heater-attached substrate. That is, the fusible conductor 5 contacts at one point of the intermediate electrode 31. Therefore, even when repeatedly exposed to a high temperature environment and a low temperature environment, the protective element 60 can prevent internal stress from being generated in the fusible conductor 5 due to a difference in linear expansion coefficients from the insulating substrate 13, and damage such as distortion and breakage from being generated. Moreover, because the heater 6 contacts the fusible conductor 5 via the insulating layer 32 and the intermediate electrode 31, the protective element 60 has excellent rapid fusing properties in which heat from the heater 6 is more readily transferred to the fusible conductor 5.

Note that, as a modified example of the protective element 40, a plurality of the heater 6 may be formed on the heater-attached substrate 7 similar to the protective element 50 (see FIG. 11). Moreover, as a modified example of the protective element 60, a plurality of the fusible conductor 5 may be formed on the base substrate 2 in the same manner as the protective element 40, or a plurality of the heater 6 may be formed on the heater-attached substrate 7 in the same manner as the protective element 50.

[Battery Pack]

Such protective elements 1, 40, 50, 60 are used, for example, by being incorporated into a circuit in a battery pack 20 of a lithium ion rechargeable battery. FIG. 12 is a circuit diagram illustrating a configuration example of a battery pack using the protective element 1. As illustrated in FIG. 12, the battery pack 20 has, for example, a battery stack 25 composed of battery cells 21a to 21d of a total of four lithium ion rechargeable batteries.

The battery pack 20 is provided with: the battery stack 25; a charge/discharge control circuit 26 that controls charging and discharging of the battery stack 25; the protective element 1 to which the present invention is applied that interrupts a charge/discharge path when the battery stack 25 is abnormal; a detection circuit 27 that detects a voltage of each battery cell 21a to 21d; and a current control element 28 that becomes a switch element that controls an operation of the protective element 1 according to a detection result of the detection circuit 27.

The battery stack 25 has the battery cells 21a to 21d connected in series that require control to protect from overcharging and overdischarging conditions, is detachably connected to a charging device 22 via a positive electrode terminal 20a and a negative electrode terminal 20b of the battery pack 20, and a charging voltage is applied from the charging device 22. The battery pack 20 charged by the charging device 22 is capable of operating an electronic device by connecting the positive electrode terminal 20a and the negative electrode terminal 20b to the electronic device operating by battery.

The charge/discharge control circuit 26 is provided with two current control elements 23a, 23b connected in series to a current path between the battery stack 25 and the charging device 22, and a control unit 24 that controls operation of these current control elements 23a, 23b. The current control elements 23a, 23b are configured by, for example, a field effect transistor (hereinafter referred to as FET), and by controlling gate voltage by the control unit 24, control is performed for conduction and interruption in a charging direction and/or a discharging direction of the current path of the battery stack 25. The control unit 24 operates by receiving power supply from the charging device 22, and controls the operation of the current control elements 23a, 23b so as to interrupt the current path when the battery stack 25 is overdischarging or overcharging according to the detection result by the detection circuit 27.

The protective element 1 is connected, for example, on the charge/discharge current path between the battery stack 25 and the charge/discharge control circuit 26, and the operation thereof is controlled by the current control element 28.

The detection circuit 27 is connected to each battery cell 21a to 21d, detects a voltage value of each battery cell 21a to 21d, and supplies each voltage value to the control unit 24 of the charge/discharge control circuit 26. Moreover, the detection circuit 27 outputs a control signal that controls the current control element 28 when any one of the battery cells 21a to 21d reaches an overcharge voltage or an overdischarge voltage.

The current control element 28 is configured by, for example, an FET, and when a voltage value of the battery cells 21a to 21d becomes a voltage that exceeds a predetermined overdischarge or overcharge state according to a detection signal output from the detection circuit 27, the protective element 1 is operated and control is performed so that the charge/discharge current path of the battery stack 25 is interrupted regardless of a switching operation of the current control elements 23a, 23b.

The protective element 1 that applies the present invention and is used in the battery pack 20 configured as described above has a circuit configuration such as that illustrated in FIG. 7. That is, in the protective element 1, the first external connection electrode 11 is connected to the battery stack 25 side, and the second external connection electrode 12 is connected to the positive electrode terminal 20a side, and thus, the fusible conductor 5 is connected in series on the charge/discharge path of the battery stack 25. Moreover, in the protective element 1, the heater 6 is connected to the current control element 28 via the first heater electrode 14 to the third external connection electrode 37, and the heater 6 is connected to an open end of the battery stack 25. In this manner, one end of the heater 6 is connected to the fusible conductor 5 and one open end of the battery stack 25 via the intermediate electrode 31, and the other end is connected to the current control element 28 and the other open end of the battery stack 25 via the third external connection electrode 33. Thus, a power supply path to the heater 6 in which supply of current can be controlled by the current control element 28 is formed.

[Operation of Protective Element]

When the detection circuit 27 detects an abnormal voltage of any one of the battery cells 21a to 21d, an interrupt signal is output to the current control element 28. Then, the current control element 28 controls the current so as to supply current to the heater 6. In the protective element 1, a current flows from the battery stack 25 to the heater 6, and thereby the heater 6 starts generating heat. In the protective element 1, the fusible conductor 5 is fused by heat generation of the heater 6 to interrupt the charge/discharge path of the battery stack 25. Moreover, in the protective element 1, the fusible conductor 5 is formed by containing a high melting point metal and a low melting point metal so that the low melting point metal melts before the high melting point metal fuses, and the fusible conductor 5 can be liquified in a short period of time by using the corrosion effect of the high melting point metal caused by the melted low melting point metal.

Here, the protective element 1 has one contact between the fusible conductor 5 supported by the base substrate 2 and the heater-attached substrate 7. Therefore, a ceramic substrate or the like is used as the insulating substrate 13 of the heater-attached substrate 7 where thermal strength is required, and even when the difference in coefficient of linear expansion from the fusible conductor 5 becomes large, the fusible conductor 5 does not suffer damage such as distortion or breakage due to internal stress when repeatedly exposed to a high temperature environment and a low temperature environment due to reflow mounting, a usage environment of a product, or the like, and has stability of an external shape and dimensions, Thus, the fusible conductor 5 is prevented from varying in fusing characteristics due to variation in resistance value due to deformation, or the like, and can maintain a high rated value and be quickly fused by heat generation of the heater 6.

In the protective element 1, the power supply path to the heater 6 is also interrupted by fusing of the fusible conductor 5, so that heat generation of the heater 6 is stopped.

Note that in the protective element 1, the fusible conductor 5 melts by self-heating even when an overcurrent exceeding a rated value is supplied to the battery pack 20, and the charge/discharge path of the battery pack 20 can be interrupted.

In this way, in the protective element 1, the fusible conductor 5 fuses due to heat generated by supply of current to the heater 6 or by self-heating of the fusible conductor 5 due to overcurrent. At this time, the protective element 1 can suppress deformation of the fusible conductor 5 by having a structure wherein the low melting point metal is covered by the high melting point metal even when the protective element 1 is reflow mounted on the circuit board or when the circuit board on which the protective element 1 is mounted is further exposed to a high temperature environment such as reflow heating. Therefore, the fusible conductor 5 is prevented from varying in fusing characteristics due to variation in resistance value due to deformation, or the like, and can be quickly fused by a predetermined overcurrent or heat generation of the heater 6.

The protective element 1 according to the present invention is not limited to use in a battery pack of a lithium ion rechargeable battery, and of course can be applied to various applications in which the current path needs to be interrupted by an electrical signal.

### REFERENCE SIGNS LIST

1 protective element, 2 base substrate, 3 first electrode, 4 second electrode, 5 fusible conductor, 6 heater, 7 heater-attached substrate. 8 retaining part, 9 conductive connection material, 11 first external connection electrode, 12 second external connection electrode, 13 insulating substrate, 14 first heater electrode, 15 second heater electrode, 16 first extraction electrode, 17 second extraction electrode, 18 low melting point metal layer, 19 high melting point metal layer, 20 battery pack, 21 battery cell, 22 charging device, 23 current control element, 24 control unit, 25 battery stack, 26 charge/discharge control circuit, 27 detection circuit, 28 current control element, 31 intermediate electrode, 32 insulating layer, 33 third external connecting electrode, 34 fourth external connection electrode, 40 protective element, 50 protective element, 60 protective element

1. A protective element comprising:
a base substrate having a first electrode and a second electrode formed thereon, the first electrode and the second electrode each being connected to an external circuit;
a fusible conductor supported on a first surface thereof by the base substrate and connected to the first electrode and the second electrode;
a heater configured to fuse the fusible conductor by generating heat; and
a heater-attached substrate having the heater provided thereon,
wherein the fusible conductor has one contact with the heater-attached substrate and the one contact is positioned on a second surface of the fusible conductor, which is an opposite surface to the first surface.

2. The protective element according to claim 1, wherein the heater is formed on a surface of the heater-attached substrate, which is an opposite surface to a surface contacting the fusible conductor.

3. The protective element according to claim 1, wherein the heater is formed on a surface of the heater-attached substrate, which is the same surface as a surface side contacting the fusible conductor.

4. The protective element according to claim 1, wherein the fusible conductor comprises a plurality of the fusible conductors, and there is one contact between each fusible conductor and the heater-attached substrate.

5. The protective element according to claim 1, wherein the heater-attached substrate is a ceramic substrate.

6. The protective element according to claim 1, wherein the base substrate has a smaller linear expansion coefficient difference relative to the fusible conductor than the heater-attached substrate.

7. The protective element according to claim 1, wherein the heater-attached substrate has a plurality of the heaters formed thereon.

8. A battery pack comprising:
one or more battery cells;
a protective element connected to a charge/discharge path of the battery cell and configured to interrupt the charge/discharge path; and
a current control element configured to detect a voltage value of the one or more battery cells and to control supply of current to the protective element, wherein
the protective element comprises:
a base substrate having a first electrode and a second electrode formed thereon, the first electrode and the second electrode each being connected to an external circuit;
a fusible conductor supported on a first surface thereof by the base substrate and connected to the first electrode and the second electrode;
a heater configured to fuse the fusible conductor by generating heat; and
a heater-attached substrate having the heater provided thereon, and
wherein the fusible conductor has one contact with the heater-attached substrate and the one contact is positioned on a second surface of the fusible conductor, which is an opposite surface to the first surface.

9. The battery pack according to claim 8, wherein the heater is formed on a surface of the heater-attached substrate, which is an opposite surface to a surface contacting the fusible conductor.

10. The battery pack according to claim 8, wherein the heater is formed on a surface of the heater-attached substrate, which is the same surface as a surface contacting the fusible conductor.

11. The battery pack according to claim 8, wherein the fusible conductor comprises a plurality of the fusible conductors, and there is one contact between each fusible conductor and the heater-attached substrate.

12. The battery pack according to claim 8, wherein the heater-attached substrate is a ceramic substrate.

13. The battery pack according to claim 8, wherein the base substrate has a smaller linear expansion coefficient difference relative to the fusible conductor than the heater-attached substrate.

14. The battery pack according to claim 8, wherein the heater-attached substrate has a plurality of the heaters formed thereon.
